(19) United States
(12) Patent Application Publication
(10) Pub. No.: US 2025/0370428 A1
(43) Pub. Date: Dec. 4, 2025

(54) ASSEMBLY PRESENTATION METHOD, ASSEMBLY PRESENTATION SYSTEM, AND PROGRAM

(71) Applicant: EXEDY Corporation, Osaka (JP)

(72) Inventor: Yoshihito UEHARA, Osaka (JP)

(21) Appl. No.: 19/219,042

(22) Filed: May 27, 2025

(30) Foreign Application Priority Data
May 30, 2024 (JP) 2024-087971

(51) Int. Cl. G05B 19/4097

(52) U.S. Cl. CPC G05B 19/4097; G05B 2219/35012

(57) ABSTRACT

The present assembly presentation method includes designing a desired assembly, generating assembly CAD data of the designed desired assembly, generating assembly-related information related to the designed desired assembly based on the assembly CAD data, and causing a second user terminal to display the assembly-related information.

### CROSS-REFERENCE TO RELATED APPLICATIONS

This application is based on and claims the priority benefit of application No. 2024-087971 filed on May 30, 2024, the contents of which are incorporated herein by reference.

### TECHNICAL FIELD

The present disclosure relates to an assembly presentation method, an assembly presentation system, and a program.

### BACKGROUND

In recent years, DIY (Do-It-Yourself) based fabrication has been widely used for making assemblies such as furniture. Specifically, a customer purchases material such as a piece of wood in a retail store such as a home improvement store and then cuts the material himself/herself or uses a material cutting service in the retail store that sells the material. Thereafter, the customer fabricates an assembly by assembling members or parts obtained from the material that was cut.

Japanese Utility Model Publication No. 3220922 discloses a system for reducing the required waiting time for a customer when ordering a material cutting service for cutting a material into members or parts in a retail store such as a home improvement store by enabling the customer to preliminarily order the cutting service over the Internet and then receive the cut members or parts at the retail store after the completion of the cutting of the material.

In the aforementioned system, as well as enabling the ordering of an assembly, a user is presented with assemblies that can be ordered over the Internet. Any of the presented assemblies can be selected. By presenting assemblies and making any of the assemblies available, the user is able to select a desired assembly after visually checking the available assemblies.

In the conventional systems, the available assemblies have been somewhat limited in design and assemblies freely designed by a given user have not been available. Further, when presenting an assembly, a photograph of the actual appearance of the assembly and required information (product name, comments, etc.) is needed for the user who is presented with the assembly.

### BRIEF SUMMARY

It is an object of the present disclosure to present a freely designed assembly and to minimize the information required to present the freely designed assembly.

An assembly presentation method according to a first aspect of the present disclosure includes:
(a) designing a desired assembly;
(b) generating assembly CAD data of the designed desired assembly;
(c) generating assembly-related information related to the designed desired assembly based on the assembly CAD data; and
(d) causing a user terminal to display the assembly-related information.

In the aforementioned assembly presentation method, it is possible to design a desired assembly, and to generate its CAD data. Based on the generated assembly CAD data, assembly-related information related to the designed desired assembly corresponding to the assembly CAD data is generated, and the generated assembly-related information is displayed on the user terminal. Accordingly, it is possible to freely design the desired assembly, and to present the assembly-related information related to the freely designed assembly via the user terminal.

In addition, since the assembly CAD data contain a large amount of information regarding the designed desired assembly, by generating the assembly-related information to be displayed on the user terminal based on the assembly CAD data, it is possible to eliminate the need for the user to provide previously required information relating to the user's desired and designed assembly, or in cases where the need to provide information may still exist, it is possible to minimize the information that the user needs to provide.

The assembly presentation method according to the first aspect may further include receiving a search keyword from the user terminal and searching assembly CAD data that include information matching the search keyword. Since the assembly CAD data contain a large amount of information regarding the designed desired assembly, by searching assembly CAD data that include information matching the search keyword from the multiple sets of assembly CAD data, it is possible to present an assembly that matches as many detailed conditions as possible. As a result, the user can select a more desirable assembly than he/she would have been able to select otherwise.

In the assembly presentation method according to the first or second aspect, generating the assembly-related information may include generating image data of the designed desired assembly indicated by the assembly CAD data as the assembly-related information based on the assembly CAD data. Accordingly, it is possible to present the appearance of the designed desired assembly to the user terminal without obtaining a photograph of the designed desired assembly or so forth.

In the assembly presentation method according to any of the first to third aspects, the assembly CAD data may contain material cutout information relating to the cutting out from a material of each member or part composing the designed desired assembly. Accordingly, when cutting out each of the members composing the designed desired assembly and ordering them, it is not required for the user who designed the desired assembly to create information regarding the material.

In the assembly presentation method according to any of the first to fourth aspects, the assembly CAD data may contain member or part information for each member or part that composes the designed desired assembly. Accordingly, it is possible to have as much detailed information as possible regarding the designed desired assembly in the assembly CAD data.

An assembly presentation system according to another aspect of the present disclosure includes a first user terminal, a server, and a second user terminal. The first user terminal is a terminal configured to design a desired assembly. The server is configured to generate assembly CAD data of the desired assembly designed with the first user terminal and generate assembly-related information related to the designed desired assembly based on the assembly CAD data. The second user terminal displays the assembly-related information generated by the server.

A program according to yet another aspect of the present disclosure causes a computer to execute the assembly presentation method recited in any of the first to fifth aspects.

According to the present disclosure, it is possible to present a freely designed assembly and to minimize providing information required for presenting the freely designed assembly.

### BRIEF DESCRIPTION OF THE DRAWINGS

FIG. 1 is a block diagram showing a configuration of an assembly presentation system according to a preferred embodiment.

FIG. 2 is a diagram showing a configuration of a server of the assembly presentation system.

FIG. 3 is a flowchart showing an operation of designing an assembly in the assembly presentation system.

FIG. 4 is a diagram showing one example of a CAD interface of the assembly presentation system.

FIG. 5 is a diagram showing one example of a configuration of assembly CAD data for the assembly presentation system.

FIG. 6 is a diagram showing one example of members or parts composing the assembly.

FIG. 7 is a diagram showing one example of material cutout information from which the members or parts are cut.

FIG. 8A is a flowchart showing an operation of presenting/ordering the assembly in the assembly presentation system.

FIG. 8B is a flowchart showing an operation of presenting/ordering the assembly in the assembly presentation system.

FIG. 9 is a diagram showing one example of a start screen for the assembly presentation system.

FIG. 10 is a diagram showing one example of assembly-related information displayed on a second user terminal for the assembly presentation system.

FIG. 11 is a diagram showing one example of a design change screen for the assembly presentation system.

### DETAILED DESCRIPTION

### 1. Assembly Presentation System

### (1) Configuration of the Assembly Presentation System

An assembly presentation system 100 according to a present preferred embodiment will be hereinafter described. The assembly presentation system 100 is a system that allows a user to design an assembly and presents information (hereinafter referred to as “assembly-related information RI”) related to the assembly designed by the user. Further, the assembly presentation system 100 allows another user to select a desired assembly based on the presented assembly-related information RI and makes the assembly selected by the “another user” available. Exemplary assemblies handled in the assembly presentation system 100 are as follows: an item of furniture, a pergola, a doghouse, a bike shelter, a car overnight bed, a car interior storage rack, and so forth.

When a user orders an assembly, the assembly presentation system 100 orders a processing business operator to cut members composing the ordered assembly from at least one material. The processing business operator hands over the cut-out members to the user. The user can complete the assembly by assembling the received members.

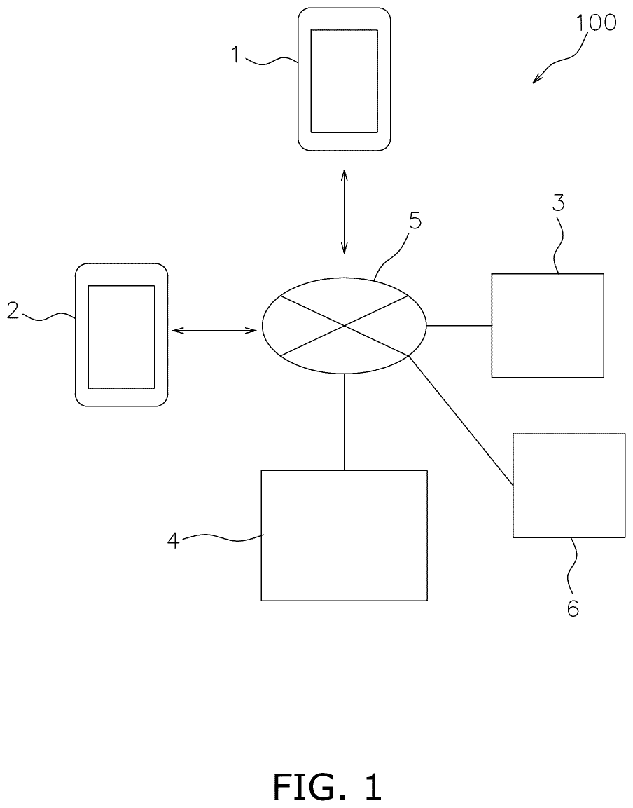

FIG. 1 is a block diagram showing a configuration of the assembly presentation system 100. As shown in FIG. 1, the assembly presentation system 100 includes a first user terminal 1, a second user terminal 2, a processing business operator terminal 3, and a server 4. The first user terminal 1, the second user terminal 2, the processing business operator terminal 3, and the server 4 are connected to each other over a network 5 (e.g., the Internet) to be communicable with each other.

Each of the first and second user terminals 1 and 2 is a computer system having a CPU (Central Processing Unit), storage devices (a RAM (Random Access Memory), a ROM (Read-Only Memory), an SSD (Solid State Drive), an HDD (Hard Disk Drive), etc.), interfaces (an input device or devices such as a keyboard, a mouse, and/or a touch screen, audio input/output devices such as a microphone and a speaker, a network interface, etc.), a display device (an OELD (Organic Electro-Luminescence Display), an LCD (Liquid Crystal Display), etc.), and so forth. Each of the first and second user terminals 1 and 2 is, for instance, a mobile terminal (e.g., a smartphone, a tablet terminal, etc.) or a personal computer.

Each of the first and second user terminals 1 and 2 is a terminal used by a user who uses the assembly presentation system 100. In the following explanation, the first user terminal 1 is defined as a terminal used by a user who designs an assembly, whereas the second user terminal 2 is defined as a terminal used by a user who browses assembly-related information. Further, the user who designs the assembly will be referred to as “design user”, whereas the user who browses the assembly-related information will be referred to as “browsing user”.

The processing business operator terminal 3 is a computer system having a CPU, storage devices (a RAM, a ROM, an SSD, an HDD, etc.), interfaces (an input device or devices such as a keyboard, a mouse, and/or a touchscreen, audio input/output devices such as a microphone and a speaker, a network interface, etc.), a display device (an OELD, an LCD, etc.), and so forth. The processing business operator terminal 3 is, for instance, a mobile terminal (e.g., a smartphone, a tablet terminal, etc.) or a personal computer.

The processing business operator terminal 3 is a terminal used by a processing business operator. The processing business operator is, for instance, a store such as a home improvement store or so forth. The processing business operator browses CAD (Computer-Aided Design) data of an assembly (hereinafter referred to as “assembly CAD data CD”) received from the server 4 with the processing business operator terminal 3 and cuts out members composing the assembly from at least one material.

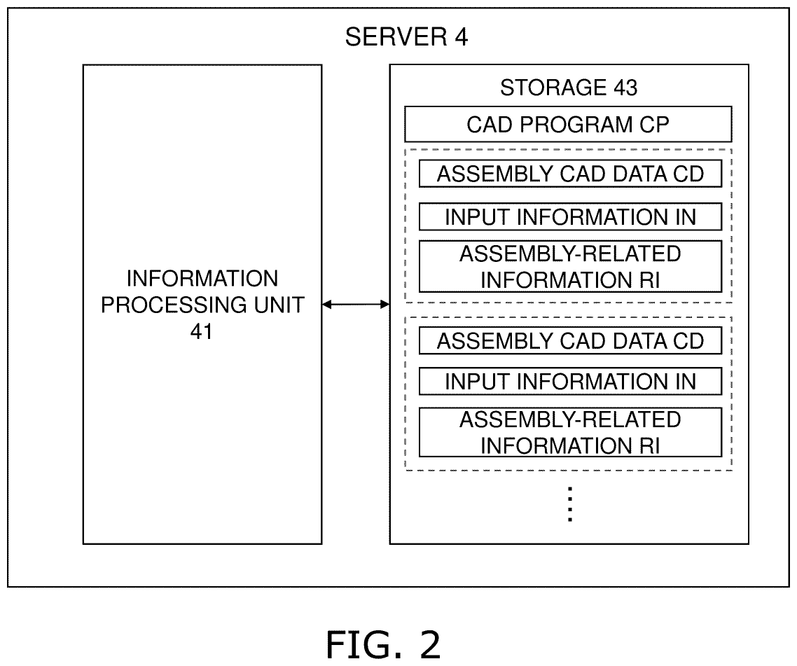

The server 4 is a computer system having a CPU, storage devices (a RAM, a ROM, an SSD, an HDD, etc.), interfaces (a network interface, etc.), and so forth. FIG. 2 is a diagram showing a configuration of the server 4. The server 4 includes an information processing unit 41 and a storage 43. The information processing unit 41 includes the CPU, the storage devices, and so forth, which are included in the server 4, and executes various information processes regarding the server 4. The information processing unit 41 realizes the various information processes by executing programs stored in the storage 43 and/or so forth. The storage 43 includes the storage devices and so forth, which are included in the server 4, and stores various programs, data, and so forth.

The information processing unit 41 allows the design user to design an assembly with the first user terminal 1 and executes information processes for generating the assembly CAD data CD of the assembly designed with the first user terminal 1. Specifically, the information processing unit 41 causes the first user terminal 1 to execute therein a CAD program CP stored in the storage 43. The design user designs the assembly with the CAD program CP executed in the first user terminal 1. The information processing unit 41 generates the assembly CAD data CD of the assembly designed by the design user with the first user terminal 1 and stores the generated assembly CAD data CD in the storage 43.

The information processing unit 41 requests the design user to input information (input information IN) when the design user designs the assembly with the first user terminal 1. The inputted input information IN is stored in the storage 43, while being associated with the assembly CAD data CD of the designed assembly. Further, the information processing unit 41 generates the assembly-related information RI, which is information related to the assembly, based on the assembly CAD data CD and/or the input information IN. The generated assembly-related information RI is stored in the storage 43, while being associated with the input information IN of the designed assembly and the assembly CAD data CD of the designed assembly.

When the server 4 is accessed by the browsing user who uses the second user terminal 2, the information processing unit 41 transmits the assembly-related information RI stored in the storage 43 to the second user terminal 2. The second user terminal 2 causes the display device thereof to display the received assembly-related information RI. Accordingly, the browsing user can browse the assembly-related information RI regarding each assembly stored in the server 4. Further, when finding a desired assembly, the browsing user can browse the detailed information of the desired assembly (e.g., the content of the entirety of the assembly CAD data CD, etc.). Moreover, the browsing user can order (the set of members of) the desired assembly with the second user terminal 2.

When browsing the assembly-related information RI with the second user terminal 2, the browsing user can search a desired assembly based on a search keyword or keywords. When receiving a search keyword or keywords for the desired assembly from the second user terminal 2, the information processing unit 41 searches information contained in the assembly CAD data of each assembly stored in the storage 43 and is thereby can extract the assembly-related information RI associated with the assembly CAD data that includes information matching the search keyword or keywords. Further, the information processing unit 41 searches the input information IN of each assembly stored in the storage 43 and thereby can extract the assembly-related information RI associated with the input information IN matching the search keyword or keywords.

The assembly presentation system 100 further includes a service operator terminal 6. The service operator terminal 6 is connected to the server 4 over the network 5 and is thereby able to communicate with the server 4. The service operator terminal 6 is a computer system having a CPU, storage devices (a RAM, a ROM, an SSD, an HDD, etc.), interfaces (an input device or devices such as a keyboard, a mouse, and/or a touch screen, audio input/output devices such as a microphone and a speaker, a network interface, etc.), a display device (an OELD, an LCD, etc.), and so forth. The service operator terminal 6 is, for instance, a mobile terminal (e.g., a smartphone, a tablet terminal, etc.) or a personal computer.

The service operator terminal 6 is a terminal used by an operator of a service provided by the assembly presentation system 100. With the service operator terminal 6, the service operator monitors whether an assembly or assemblies designed by the design user is identical or comparable to a previously designed and existing assembly or not. Specifically, with the service operator terminal 6, the service operator monitors whether a plurality of identical/comparable assemblies exist or not by browsing the assembly CAD data CD, the input information IN, and/or the assembly-related information RI of each assembly stored in the storage 43 of the server 4.

For example, the service operator can perform the following as a countermeasure to prevent duplication of identical/comparable assemblies: issuing an alert to the design user who designed an assembly identical/comparable to the assembly designed in the past, and deleting the data (the assembly CAD data CD, the input information IN, and/or the assembly-related information RI) related to the assembly that is identical/comparable to the previously designed assembly.

It should be noted that the server 4 is also capable of automatically executing the aforementioned monitoring of identical/comparable assemblies. For example, with an AI model by which image comparison is implementable, the server 4 can find whether a plurality of identical/comparable assemblies exist in the assembly CAD data CD, the input information IN, and/or the assembly-related information RI stored in the storage 43 of the server 4.

The service operator gives a predetermined incentive to a design user who designed an assembly having detailed information browsed by the browsing user, and/or a design user who designed an assembly ordered by the browsing user. For example, the incentives to be given to such design users as described above are incentives beneficial for the design users, such as refunds, providing points available in the service provided by the assembly presentation system 100, and royalties for data of the assembly.

### (2) Operation of Assembly Presentation System

### (2-1) Designing Assembly

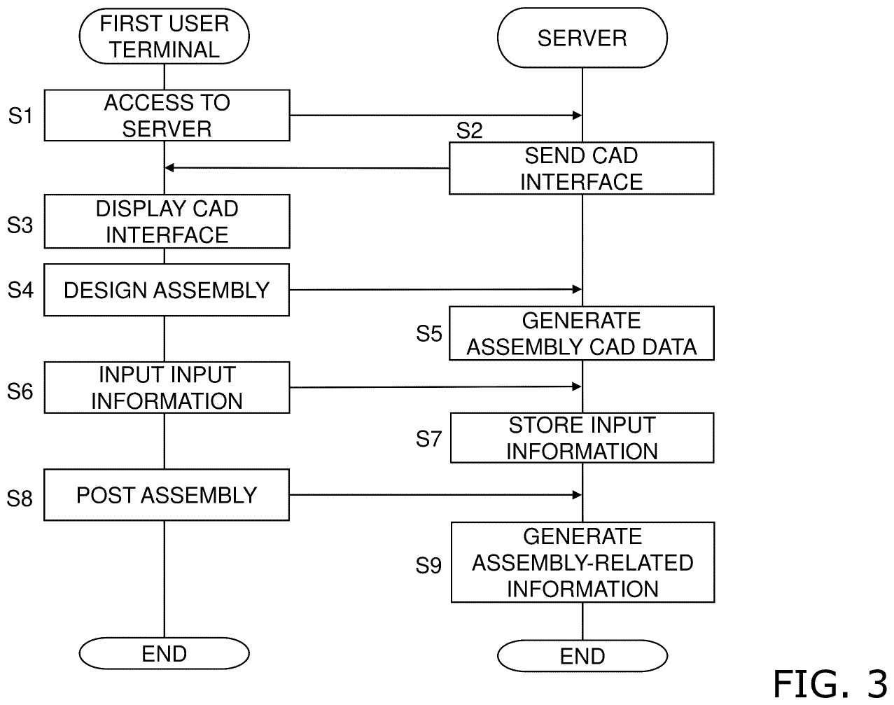

An operation to be performed in the assembly presentation system 100 configured as described above will be hereinafter described. First, the operation of designing an assembly in the assembly presentation system 100 will be described with reference to FIG. 3. FIG. 3 is a flowchart showing the operation of designing an assembly in the assembly presentation system 100.

First, the design user accesses the server 4 with the first user terminal 1 (step S1). Specifically, for instance, the design user causes the first user terminal 1 to execute a web browser and accesses the address (e.g., the URL (Uniform Resource Locator)) of the server 4 for designing an assembly on the web browser.

When the address for designing an assembly is accessed by the first user terminal 1, the information processing unit 41 of the server 4 executes a process of making the CAD program CP executable in the first user terminal 1. Specifically, the information processing unit 41 executes the CAD program CP and transmits a CAD interface CI to the first user terminal 1 to enable the first user terminal 1 to remotely operate the CAD program CP executed in the server 4 (step S2).

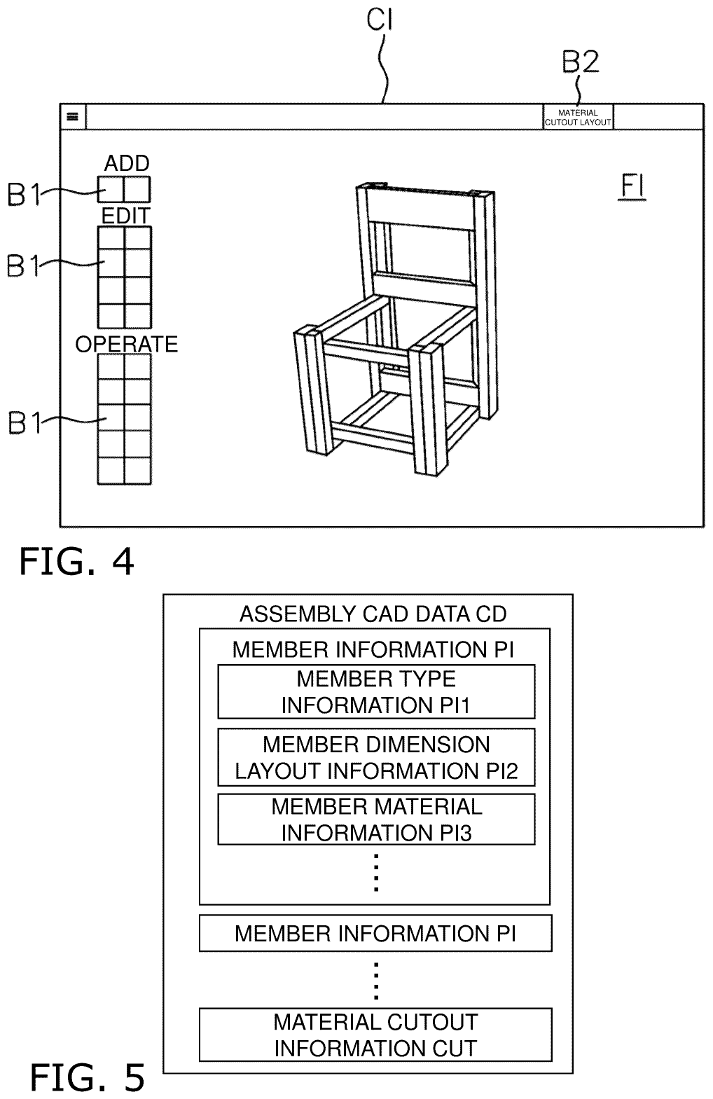

For example, an interface shown in FIG. 4 can be the CAD interface CI. FIG. 4 is a diagram showing one example of the CAD interface CI. In the CAD interface CI, a field FI for drawing an assembly, a variety of tool buttons B1 for drawing an assembly, a cutout information button B2 for editing material cutout information CUT, and so forth are provided.

When receiving the CAD interface CI, the first user terminal 1 causes the display device thereof to display the received CAD interface CI (step S3). Specifically, the first user terminal 1 causes the web browser, executed therein to be used for accessing the server 4, to display the CAD interface CI.

When the CAD interface CI is displayed on the first user terminal 1, the design user designs an assembly by drawing the assembly on the CAD interface CI displayed on the first user terminal 1 (step S4). When drawing of the assembly is completed, the information processing unit 41 executes the CAD program CP to generate the assembly CAD data CD by converting the assembly displayed on the CAD interface CI into CAD data having a predetermined format (step S5).

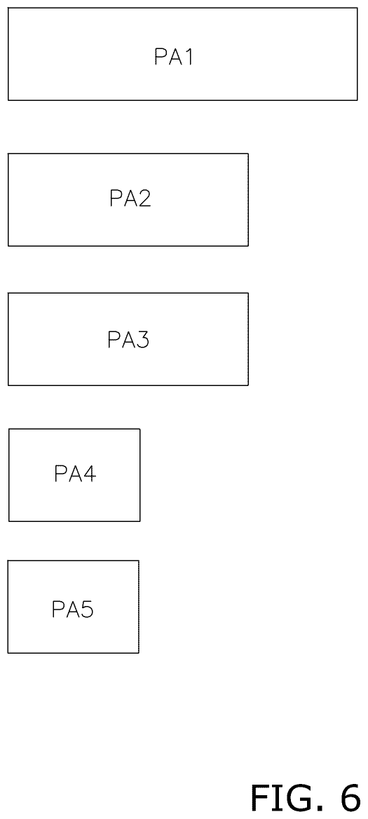

Specifically, the information processing unit 41 generates the assembly CAD data CD as shown in FIG. 5. FIG. 5 is a diagram showing one example of the assembly CAD data CD. The assembly CAD data CD contains member information PI and the material cutout information CUT.

The member information PI is information related to each of the members composing an assembly. The number of the member information PI to be generated is the number of members composing the assembly. The member information PI includes member type information PI1, member dimension layout information PI2, member material information PI3, and so forth.

The member type information PI1 is information related to the type or attributes of a corresponding member. The member type information PI1 contains, for instance, “wood” indicating that the corresponding member is made of wood, “plank” indicating that the corresponding member is made of plank, “plywood” indicating that the corresponding member is made of plywood, “column” indicating that the corresponding member is made in the shape of a column (round rod), “disc” indicating that the corresponding member is made in the shape of a disc, and so forth.

The member dimension layout information PI2 is information related to the dimension of the corresponding member and the position of the corresponding member in the assembly. The member dimension layout information PI2 contains, for instance, the dimensions of the corresponding member (width, length, and thickness), the position of the corresponding member with respect to a reference position (e.g., center position) in the assembly, the orientation of the corresponding member, and so forth.

The member material information PI3 is information related to a material from which the corresponding member is cut out. The member material information PI3 contains, for instance, the name of the material, the color of the material, the specular reflection coefficient of the material, the dimensions of the material (width, length, and thickness), the specific gravity of the material, the price of the material, the name of the manufacturer of the material, the brand name of the material, and so forth.

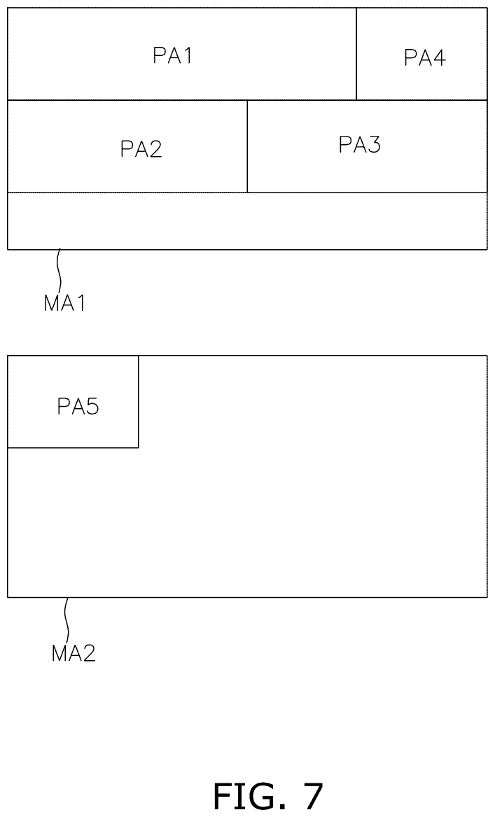

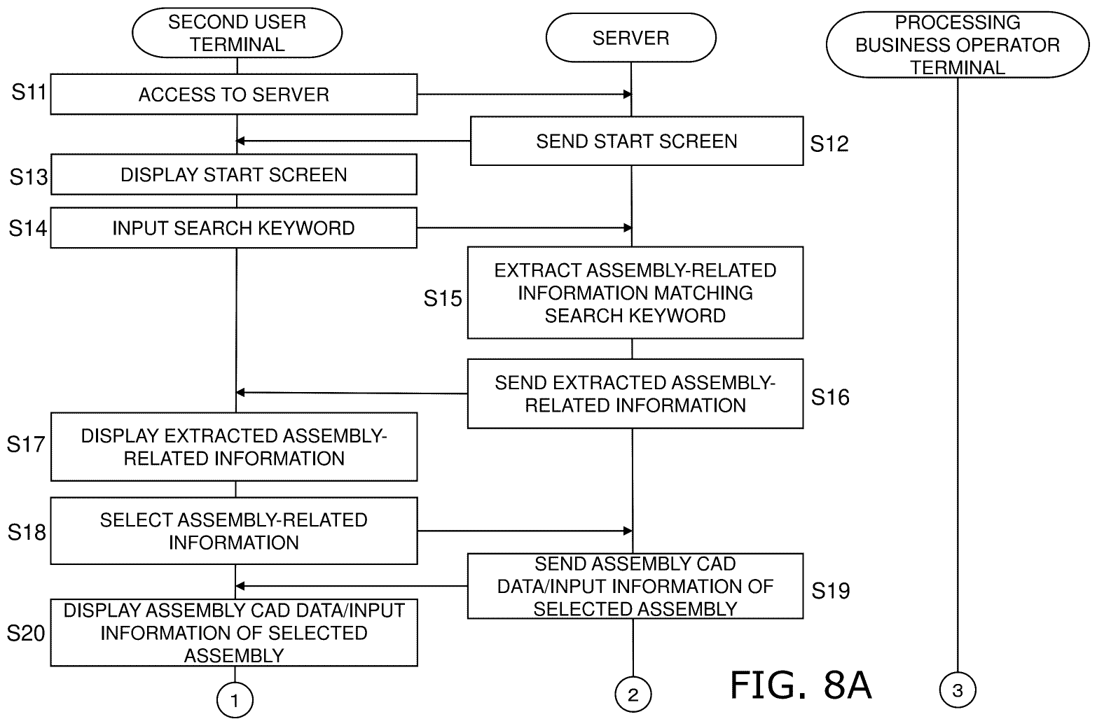

The material cutout information CUT is information related to cutting out of the members composing the assembly from a material or materials. In other words, the material cutout information indicates how the members are cut out from the material or materials. When the assembly is composed of, for instance, five members PA1 to PA5 as shown in FIG. 6, the material cutout information CUT to be generated indicates that the members PA1 to PA5 are cut out from, for instance, rectangular materials MA1 and MA2 as shown in FIG. 7. It should be noted that the design user can edit the cutout layout of the members indicated by the material cutout information CUT on the CAD interface CI. FIG. 6 is a diagram showing one example of members composing an assembly. FIG. 7 is a diagram showing one example of the material cutout information CUT.

The information processing unit 41 executing the CAD program CP can not only generate the assembly CAD data CD from the drawing of the assembly but also (conversely) reproduce an image representing the appearance of the assembly (drawing data of the assembly) from the sets of member information PI contained in the assembly CAD data CD and so forth. Further, the processing business operator can grasp the material or materials of the assembly and the method of cutting out the members from the material or materials by browsing the material cutout information CUT contained in the assembly CAD data CD with the processing business operator terminal 3.

Now, the rest of the operations to be performed for designing an assembly will be described. The design user can input information regarding the designed assembly as the input information IN with the first user terminal 1 (step S6). It should be noted that inputting of the input information IN may be skipped. For example, the following can be inputted as the input information IN: the name of the assembly (e.g., shelf/rack, desk, etc.), the purpose of use of the assembly, and/or a variety of comments regarding the assembly. In addition, a keyword or keywords attached with “hashtag” important for the assembly may be described in the input information IN. Accordingly, when a search is performed with a search keyword in browsing the assembly, matching of the important keyword or keywords can be made easier.

The input information IN, inputted with the first user terminal 1, is transmitted to the server 4. When the server 4 receives the input information IN, the information processing unit 41 stores the received input information IN in the storage 43, associating the received input information IN with the assembly CAD data CD of the corresponding assembly (step S7).

After designing the assembly, if the design user wants to release the designed assembly, the design user performs “posting” of the designed assembly with the first user terminal 1 (step S8). For example, posting of the designed assembly is made by performing an operation of posting the assembly (e.g., pressing a posting button) in the first user terminal 1.

When the operation of posting the assembly is performed in the first user terminal 1, the information processing unit 41 of the server 4 detects that the posting operation has been performed in the first user terminal 1 and generates the assembly-related information RI regarding the designed assembly (step S9). The assembly-related information RI is generated for enabling the browsing user to browse the designed assembly.

Specifically, based on the assembly CAD data CD of the posted assembly, the information processing unit 41 generates image data of the posted assembly represented by the assembly CAD data CD as the assembly-related information RI. The information processing unit 41 executing the CAD program CP can reproduce the image data representing the appearance of the posted assembly from the information contained in the assembly CAD data CD of the posted assembly (e.g., sets of member information PI). For example, the information processing unit 41 can generate a thumbnail image to be displayed on the second user terminal 2 based on the assembly CAD data CD.

In addition, the information processing unit 41 can also generate the assembly-related information RI based on the assembly CAD data CD and/or the input information IN. For example, the information processing unit 41 can generate briefing of the assembly (e.g., summary of the content of the input information IN) as the assembly-related information RI. For example, the information processing unit 41 can generate briefing of the assembly based on the assembly CAD data CD and/or the input information IN with a generative AI model and set the briefing of the assembly as the assembly-related information RI.

The information processing unit 41 stores the assembly-related information RI generated as described above in the storage 43, associating it with the assembly CAD data CD and the input information IN of the corresponding assembly.

As described above, by providing the CAD interface CI to the first user terminal 1, the design user can freely design the desired assembly. In addition, by generating the assembly CAD data CD of the assembly designed on the CAD interface CI and then generating the assembly-related information RI to be browsed by the browsing user based on the assembly CAD data CD, it is possible to eliminate the necessity for the design user to provide information required for presenting the assembly designed by the design user, or even if the necessity exists, to minimize the information to be provided by the design user. For example, it is not required for the design user to provide, as the input information IN, the information contained in the assembly CAD data CD such as the color of the designed assembly, the detailed dimensions of the designed assembly, the material or materials to be used for the designed assembly, and so forth.

### (2-2) Presentation/Ordering Assembly

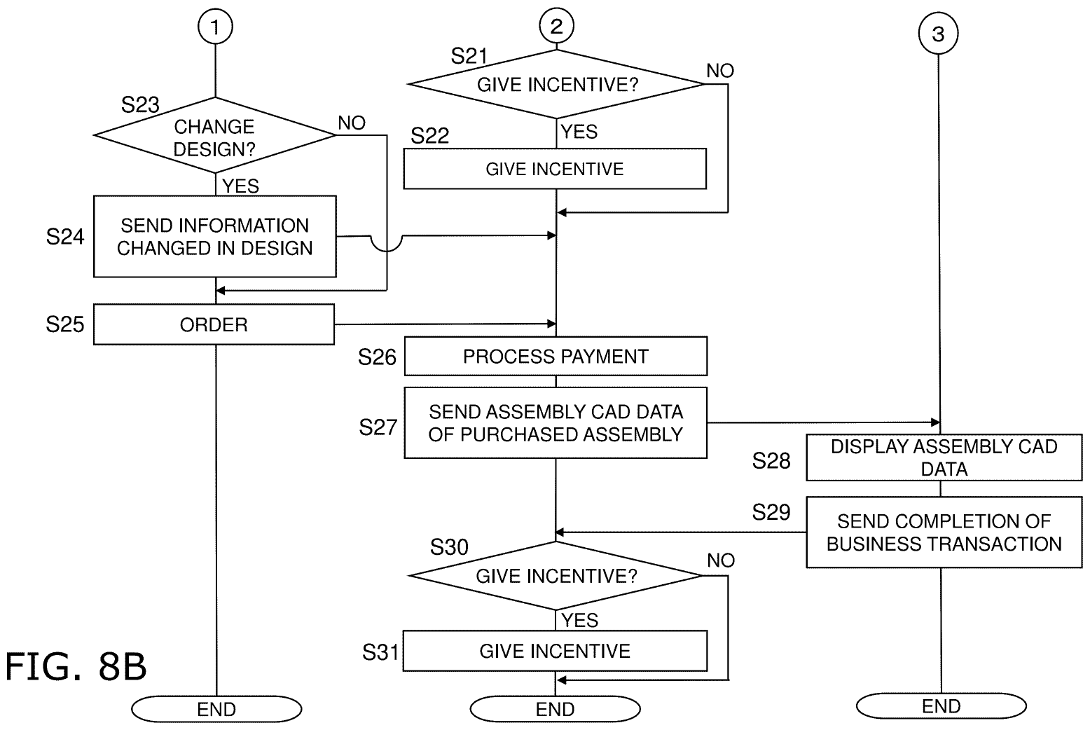

Next, an operation of presenting/ordering an assembly in the assembly presentation system 100 will be described with reference to FIGS. 8A and 8B. FIGS. 8A and 8B are flowcharts showing the operations of presenting/ordering an assembly in the assembly presentation system 100.

First, the browsing user accesses the server 4 with the second user terminal 2 (step S11). Specifically, for instance, the browsing user causes the second user terminal to execute a web browser and access the address (e.g., the URL) of the server 4 for browsing assemblies on the web browser.

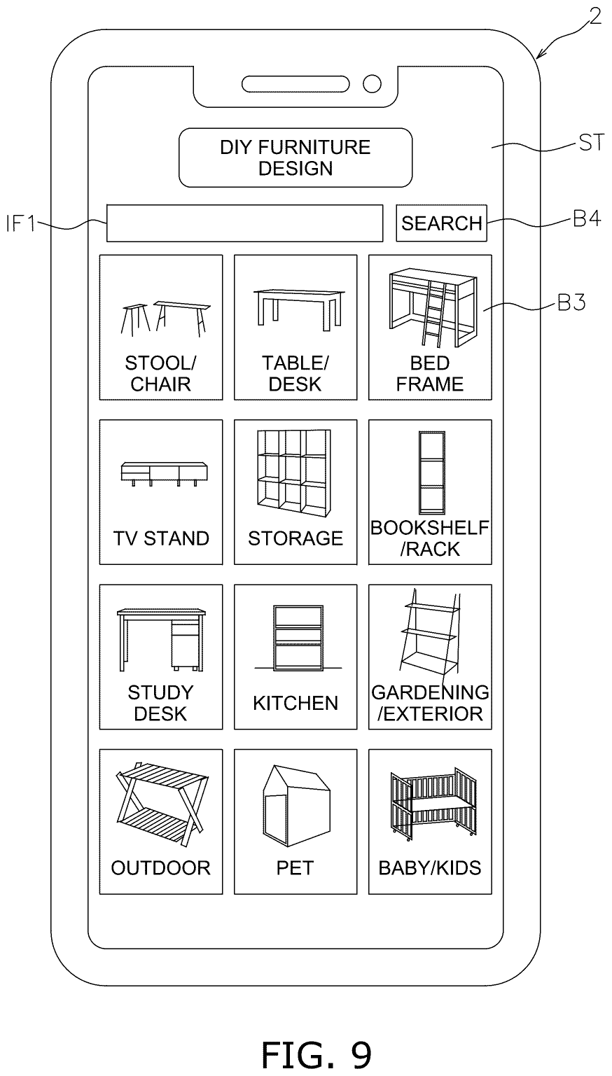

When the address for browsing assemblies is accessed by the second user terminal 2, the information processing unit 41 of the server 4 transmits a start screen ST shown in FIG. 9 to the second user terminal 2 (step S12). The start screen ST includes, for instance, link buttons B3, each of which is provided for displaying the assembly-related information RI of each assembly on a type or attribute basis, a keyword input interface IF1, and a search button B4. FIG. 9 is a diagram showing one example of the start screen ST.

When receiving the start screen ST, the second user terminal 2 causes the display device thereof to display the received start screen ST (step S13). Specifically, the second user terminal 2 causes the web browser, executed therein to be used for accessing the server 4, to display the start screen ST.

When the start screen ST is displayed on the second user terminal 2, the browsing user browses a desired one of the assemblies by pressing one of the link buttons B3 on the start screen ST or by inputting a search keyword or keywords in the keyword input interface IF1 and then pressing the search button B4 on the start screen ST. In the following, browsing with a search keyword or keywords will be described as one example of browsing. It should be noted that when one of the link buttons B3 is pressed, the assembly-related information RI of the specified type of the assembly (desk, chair, rack, etc.) is displayed on the second user terminal 2.

When the browsing user inputs a search keyword or keywords in the keyword input interface IF1 and then presses the search button B4 on the start screen ST displayed on the second user terminal 2 (step S14), the inputted search keyword or keywords and a command for executing searching with the search keyword or keywords are transmitted to the server 4. When the server 4 receives the search keyword or keywords and the aforementioned command, the information processing unit 41 extracts the assembly-related information RI of an assembly matching the search keyword or keywords by executing searching with the search keyword or keywords (step S15).

Specifically, the information processing unit 41 searches whether the assembly CAD data CD and/or the input information IN that contain information matching the received search keyword or keywords have been stored or not in the storage 43. When the assembly CAD data CD and/or the input information IN that contain the information matching the search keyword or keywords have been stored in the storage 43, the information processing unit 41 extracts the assembly-related information RI, associated with the assembly CAD data CD and/or the input information IN that contain the information matching the search keyword or keywords, as the assembly-related information RI of the assembly matching the search keyword or keywords.

For example, if the search keywords “shelf/rack made of wood” are inputted, the information processing unit 41 can extract the assembly-related information RI associated with both the input information IN containing information related/comparable to “shelf/rack” and the assembly CAD data CD containing the member information PI in which the member type information PI1 is “wood”.

For example, if the search keywords “red shelf/rack” are inputted, the information processing unit 41 can extract the assembly-related information RI associated with both the input information IN containing information related/comparable to “shelf/rack” and the assembly CAD data CD containing the member information PI in which “the color of material” contained in the member material information PI3 is “red”.

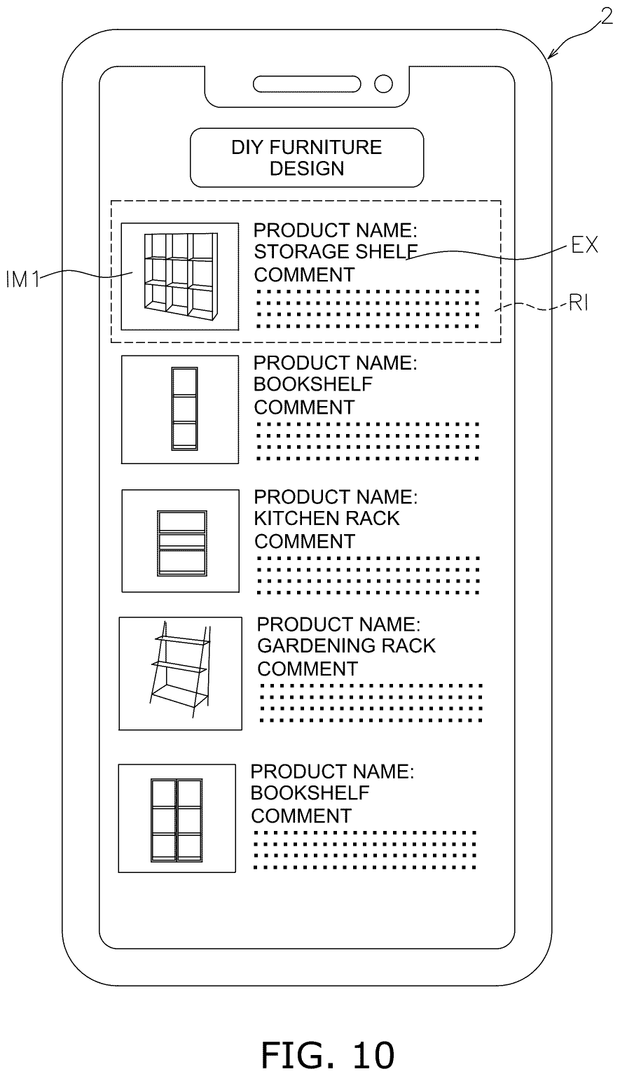

The information processing unit 41 transmits the assembly-related information RI extracted based on searching to the second user terminal 2 (step S16). When receiving the aforementioned assembly-related information RI, the second user terminal 2 causes the display device thereof to display the received assembly-related information RI (step S17). For example, as shown in FIG. 10, multiple sets of assembly-related information RI, transmitted to the second user terminal 2 from the server 4, are displayed in the form of a list on the display device of the second user terminal 2. FIG. 10 is a diagram showing one example of the multiple sets of assembly-related information RI displayed on the second user terminal 2.

As shown in FIG. 10, each set of assembly-related information RI contains, for instance, a first appearance image IM1 representing the appearance of an assembly (e.g., a thumbnail image) and explanation information EX that is textual information for explaining the assembly. The explanation information EX can include, for instance, the name of the assembly (product name) and the outline of a comment regarding the assembly. In addition, the assembly-related information RI contains a hyperlink to the assembly CAD data CD and/or the input information IN, each of which is associated therewith.

When any of the multiple sets of assembly-related information RI displayed in the form of a list on the display device of the second user terminal 2 is selected (step S18) by, for instance, either hovering a cursor over any of the multiple sets of assembly-related information RI and then clicking the input device or touching any of the multiple sets of assembly-related information RI, the information processing unit 41 of the server 4 transmits the assembly CAD data CD and the input information IN that are associated with the selected assembly-related information RI (step S19).

When receiving the assembly CAD data CD and the input information IN that are associated with the selected assembly-related information RI, the second user terminal 2 causes the display device thereof to display the received assembly CAD data CD and input information IN (step S20). In this way, the browsing user can browse details of the assembly CAD data CD and the input information IN of the selected assembly.

As described above, when the browsing user can browse the details of the assembly CAD data CD and the input information IN of the selected assembly, the information processing unit 41 of the server 4 determines whether or not to give the design user, who designed the selected assembly, the incentive attributed to browsing of the details of the assembly CAD data CD and the input information IN of the selected assembly by the browsing user (step S21). For example, when designing the assembly, the design user can set whether or not to receive the incentive in this phase with the first user terminal 1.

When the design user, who designed the selected assembly, wants to receive the incentive in this phase (“YES” in step S21), the information processing unit 41 executes a process of giving the incentive to the design user (step S22). For example, if the information processing unit 41 executes a process of giving points to the design user, a process of paying money to the design user, or so forth; alternatively, the information processing unit 41 transmits a notification to the service operator terminal 6 to cause the service operator to execute the process herein described. Alternatively, when the design user does not want to receive the incentive in this phase (“NO” in step S21), the information processing unit 41 skips execution of the process in step S22.

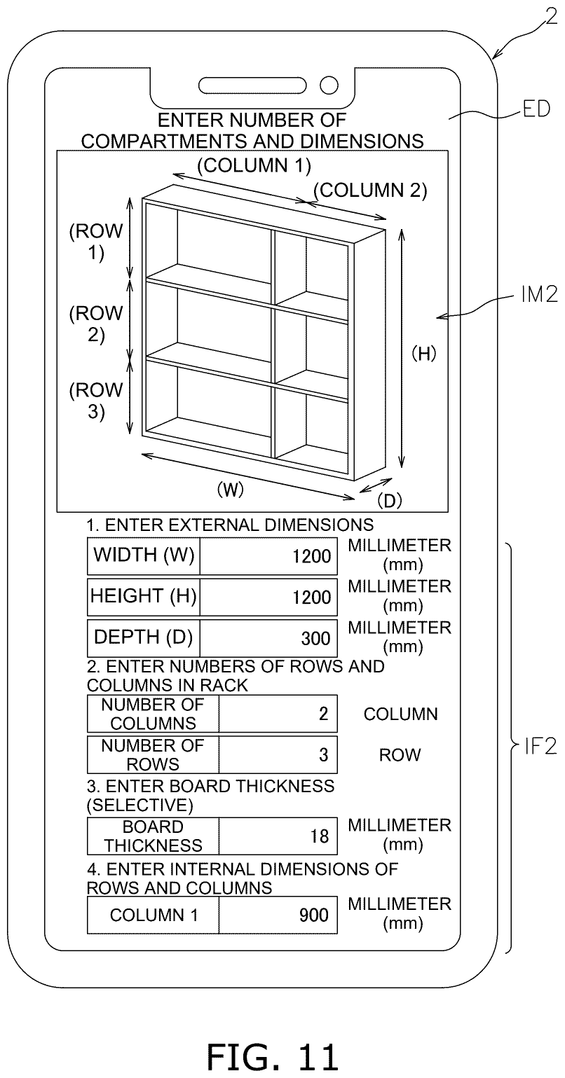

In addition, when enabled to browse the details of the assembly CAD data CD and the input information IN of the selected assembly, the browsing user can also change the design of the selected assembly with the second user terminal 2. For example, the browsing user causes the second user terminal 2 to display such a design change screen ED as shown in FIG. 11 and can thereby change the design of the selected assembly on the design change screen ED. FIG. 11 is a diagram showing one example of the design change screen ED.

For example, a second appearance image IM2 representing the appearance of an assembly to be changed in design and a design change interface IF2 for changing the assembly in design are displayed on the design change screen ED. On the design change screen ED shown in FIG. 11, the assembly (shelf/rack) can be changed in design by directly inputting the external dimensions, the number of compartments, the board thickness, and so forth of the assembly with the design change interface IF2.

When the assembly is changed in design with the design change screen ED (“YES” in step S23), the second user terminal 2 transmits information regarding the design-changed assembly to the server 4 (step S24). The information regarding the design-changed assembly is, for instance, information regarding which one has been changed among the multiple sets of information contained in the assembly CAD data CD and the value of the changed information. In other words, even if the assembly is changed in design by the browsing user, the design change is not reflected to the assembly CAD data CD stored in the storage 43.

Alternatively, when the selected assembly has not been changed in design (“NO” in step S23), execution of the aforementioned process in step S24 is skipped.

Thereafter, when the browsing user orders the selected assembly with the second user terminal 2 (step S25), a process of ordering is executed. Ordering of the assembly with the second user terminal 2 is made, for instance, when an order button (displayed on the display device) is pressed in the second user terminal 2 and the server 4 is notified of pressing of the order button in the second user terminal 2.

When the server 4 is notified of ordering of the assembly, the information processing part 41 executes a process of payment for browsing user to purchase the ordered assembly (step S26). Further, the information processing part 41 transmits the assembly CAD data CD of the ordered assembly to the processing business operator terminal 3 (step S27).

When the ordered assembly has been changed in design, the information processing unit 41 temporarily changes the information contained in the assembly CAD data CD based on the information regarding the design-changed assembly received in step S24 and then transmits the assembly CAD data CD changed in information to the processing business operator terminal 3.

When receiving the assembly CAD data CD, the processing business operator terminal 3 causes the display device thereof to display the received assembly CAD data CD (step S28). The processing business operator selects a material or materials, from which the respective members of the ordered assembly are cut out, with reference to the assembly CAD data CD displayed on the processing business operator terminal 3 and then cuts out the respective members from the selected material or materials.

When the browsing user receives the cut-out members of the assembly and thus the business transaction with the browsing user is done, the processing business operator notifies the server 4 of completion of the business transaction with the processing business operator terminal 3 (step S29).

When the server 4 is notified of completion of the business transaction, the information processing unit 41 determines whether or not to give the incentive attributed to purchasing of the ordered assembly to the design user who designed the ordered assembly (step S30). For example, when designing the ordered assembly, the design user can set whether or not to receive the incentive in this phase with the first user terminal 1.

It should be noted that, with the first user terminal 1, the design user can arbitrarily set any of the following as a response to the incentives: receiving only the incentive attributed to browsing of the details of the assembly CAD data CD and the input information IN of the assembly by the browsing user, receiving only the incentive attributed to purchasing of the assembly, receiving both of the incentives, and not receiving any of the incentives.

When the design user wants to receive the incentive attributed to purchasing of the assembly (“YES” in step S30), the information processing unit 41 executes the process of giving the incentive to the design user who designed the purchased assembly (step S31). For example, the information processing unit 41 executes the process of giving points to the design user, the process of paying money to the design user, or so forth; alternatively, the information processing unit 41 transmits a notification to the service operator terminal 6 to cause the service operator to execute the process herein described.

It should be noted that the incentive attributed to browsing of the details of the assembly CAD data CD and the input information IN of the assembly by the browsing user and that attributed to purchasing of the assembly may be identical/different in type to/from each other. For example, the incentive attributed to browsing of the details of the assembly CAD data CD and the input information IN of the assembly by the browsing user can be set as giving points to the design user, whereas the incentive attributed to purchasing of the assembly can be set as paying money to the design user (e.g., the amount of money corresponding to a predetermined percentage of the price for purchasing). Alternatively, for instance, points to be given to the design user in purchasing of the assembly can be set to be greater than those to be given to the design user in browsing of the details of the assembly CAD data CD and the input information IN of the assembly by the browsing user.

Alternatively, when the design user does not want to receive any incentives in this phase (“NO” in step S30), the information processing unit 41 skips execution of the process in step S31.

With the aforementioned operation of presenting/ordering an assembly, the browsing user can find and order an assembly that is suitable for user's own preference as much as possible by browsing a variety of assemblies designed by an arbitrary design user. Further, with the aforementioned operation of presenting/ordering an assembly, the browsing user can change the design of the assembly suitable for user's own preference in accordance with user's own purpose of use of the assembly or so forth on an as-needed basis.

### 2. Other Preferred Embodiments

One preferred embodiment of the present disclosure has been described above. However, the present disclosure is not limited to the preferred embodiment described above, and a variety of changes can be made without departing from the gist of the present disclosure. It should be noted that basically speaking, respective modifications to be described are applicable simultaneously.
(a) The order of executing the respective steps in the flowcharts shown in FIGS. 3, 8A, and 8B and the contents of the processes in the respective steps can be changed without changing the gist of the present disclosure.
(b) In the preferred embodiment described above, an assembly is designed with the CAD interface CI displayed on the web browser executed in the first user terminal 1. However, designing an assembly in the first user terminal 1 is not limited to this; by executing an application exclusively for designing an assembly in the first user terminal 1, it is possible to design an assembly on the application as well.
(c) In the preferred embodiment described above,

information (e.g., the assembly-related information RI) browsed by the browsing user is displayed on the web browser executed in the second user terminal 2. However, handling the information in the second user terminal 2 is not limited to this; by executing an application exclusively for displaying/browsing information regarding an assembly in the second user terminal 2, it is possible to display/browse the information regarding an assembly on the application as well.
(d) The design user, the browsing user, and/or the processing business operator may be an identical user. Further, the first user terminal 1, the second user terminal 2, and/or the processing business operator terminal 3 may be an identical terminal.
(e) The assembly-related information RI may be generated based on the assembly CAD data CD and/or the input information IN of the specified assembly, not when an assembly is designed but when browsing of assemblies is requested by the browsing user and any of the assemblies is specified as the one desired for browsing.

### 3. Appendixes

(First aspect) An assembly presentation method includes (a) to (d). It should be noted that letters in parenthesis (a) to (d) do not limit the order of executing processes:
(a) designing a desired assembly (e.g., steps S1 to S4);
(b) generating assembly CAD data (e.g., the assembly CAD data CD) of the designed desired assembly (e.g., step S5);
(c) generating assembly-related information (e.g., the assembly-related information RI) related to the designed desired assembly based on the assembly CAD data (e.g., step S9); and
(d) causing a user terminal (e.g., the second user terminal 2) to display the assembly-related information (e.g., steps S11 to S17).

In the aforementioned assembly presentation method, it is possible to design a desired assembly, and to generate its CAD data. Based on the generated assembly CAD data, assembly-related information related to the designed desired assembly corresponding to the assembly CAD data is generated, and the generated assembly-related information is displayed on the user terminal. Accordingly, it is possible to freely design the desired assembly, and to present the assembly-related information related to the freely designed assembly via the user terminal.

In addition, since the assembly CAD data contain a large amount of information regarding the designed desired assembly, by generating the assembly-related information to be displayed on the user terminal based on the assembly CAD data, it is possible to eliminate the need for the user to provide previously required information relating to the user's desired and designed assembly, or in cases where the need to provide information may still exist, it is possible to minimize the information that the user needs to provide.

(Second aspect) The assembly presentation method according to the first aspect may further include receiving a search keyword from the user terminal (e.g., step S14) and searching assembly CAD data that include information matching the search keyword (e.g., step S15). Since the assembly CAD data contain a large amount of information regarding the designed desired assembly, by searching assembly CAD data that include information matching the search keyword, it is possible to present an assembly that matches as many detailed conditions as possible. As a result, the user can select a more desirable assembly than he/she would have been able to select otherwise.

(Third aspect) In the assembly presentation method according to the first or second aspect, generating the assembly-related information may include generating image data (e.g., the first appearance image IM1) of the designed desired assembly indicated by the assembly CAD data as the assembly-related information based on the assembly CAD data. Accordingly, it is possible to present the appearance of the designed desired assembly to the user terminal without obtaining a photograph of the designed desired assembly or so forth.

(Fourth aspect) In the assembly presentation method according to any of the first to third aspects, the assembly CAD data may contain material cutout information (e.g., the material cutout information CUT) relating to the cutting out from a material of each member or part composing the designed desired assembly. Accordingly, when cutting out each of the members composing the designed desired assembly and ordering them, it is not required for the user who designed the desired assembly to create information regarding the material.

(Fifth aspect) In the assembly presentation method according to any of the first to fourth aspects, the assembly CAD data may contain member or part information (e.g., the member information PI) for each member or part that composes the designed desired assembly. Accordingly, it is possible to have as much detailed information as possible regarding the designed desired assembly in the assembly CAD data.

(Sixth aspect) An assembly presentation system (e.g., the assembly presentation system 100) includes a first user terminal (e.g., the first user terminal 1), a server (e.g., the server 4), and a second user terminal (e.g., the second user terminal 2). The first user terminal is a terminal configured to design a desired assembly. The server is configured to generate assembly CAD data of the desired assembly designed with the first user terminal and generate assembly-related information related to the designed desired assembly based on the assembly CAD data. The second user terminal displays the assembly-related information generated by the server.

(Seventh aspect) A program causes a computer to execute the assembly presentation method recited in any of the first to fifth aspects.

1. An assembly presentation method comprising:
designing a desired assembly;
generating assembly CAD data of the designed desired assembly;
generating assembly-related information related to the designed desired assembly based on the assembly CAD data; and
causing a user terminal to display the assembly-related information.

2. The assembly presentation method according to claim 1, further comprising:
receiving a search keyword from the user terminal; and
searching assembly CAD data that include information matching the search keyword.

3. The assembly presentation method according to claim 1, wherein generating the assembly-related information includes generating image data of the designed desired assembly indicated by the assembly CAD data as the assembly-related information based on the assembly CAD data.

4. The assembly presentation method according to claim 1, wherein the assembly CAD data contain material cutout information relating to the cutting out from a material of each member comprising the designed desired assembly.

5. The assembly presentation method according to claim 1, wherein the assembly CAD data contain member information for each member that composes the designed desired assembly.

6. An assembly presentation system comprising:
a first user terminal configured to design a desired assembly;
a server configured to generate assembly CAD data of the desired assembly designed with the first user terminal, and configured to generate assembly-related information related to designed desired assembly based on the assembly CAD data; and
a second user terminal configured to display the assembly-related information generated by the server.

7. A program causing a computer to execute the assembly presentation method according to claim 1.
